(19) United States
(12) Patent Application Publication
(10) Pub. No.: US 2009/0225031 A1
(43) Pub. Date: Sep. 10, 2009

(54) Optical mouse

(75) Inventor: Eul Sung Kim, Gyeonggi-do (KR)

Correspondence Address: OLIFF & BERRIDGE, PLC, P.O. BOX 320850, ALEXANDRIA, VA, 22320-4850, US

(73) Assignee: WOW TECHNOLOGY INC., SEONGNAM-SI (KR)

(21) Appl. No.: 11/989,834

(22) PCT Filed: Aug. 1, 2006
(86) PCT No.: PCT/KR2006/003014

§ 371 Date: Feb. 1, 2008

(30) Foreign Application Priority Data
Aug. 4, 2005 (KR) 10-2005-0071280

(51) Int. Cl. G06F 3/033

(52) U.S. Cl. 345/166

(57) ABSTRACT

Disclosed herein is an optical mouse. A body of the mouse has a bottom area sufficient to stand up independently and also has a pen shape to be wrapped around and gripped by the user's thumb and index finger. The pen shaped body is formed with a protruding portion having an inclined surface to allow the user's middle finger to rest thereon in a state wherein the user's thumb and index finger wrap around and grip the body and the middle finger is bent. The optical mouse causes no stress on the user's wrist in use by virtue of the pen shaped body, and has stability and accuracy by virtue of a bottom area thereof to allow the mouse to stand up independently, and can be easily assembled by using a standard optical lens, resulting in improved productivity and reduced production costs.

### TECHNICAL FIELD

The present invention relates to an optical mouse, and more particularly, to an optical mouse having a body capable of eliminating drawbacks of both a desktop mouse and pen mouse.

### BACKGROUND ART

A mouse is an input device essential for a computer together with a keyboard. In particular, recent developments of window operating systems and internet have caused rapid increases in the number of people and time spent using computers, and thus, a mouse has become an indispensable device. Such a mouse may be basically classified into a traditional desktop mouse and a pen mouse.

In the case of a desktop mouse, although it provides a stability in use by virtue of a wide bottom surface thereof, there is a problem in that a user has to bend his/her wrist to operate the desktop mouse and therefore, modern people who use a desktop mouse for a long time may experience excessive stress on their wrist. In the case of a pen mouse, although it is relatively small and has a shape convenient to grip, the pen mouse has problems of low stability and accuracy due to a narrow bottom surface thereof. Furthermore, as the small size thereof is increasingly highlighted, the pen mouse has a necessity of much smaller constituent elements, and thus, suffers from deterioration of productivity, etc.

### DISCLOSURE

### Technical Problem

Therefore, the present invention has been made in view of the above problems, and it is an object of the present invention to provide an optical mouse, which can achieve not only a stability in use, but also an improved productivity without causing stress on the user's wrist.

### Technical Solution

In accordance with an aspect of the present invention, the above and other objects can be accomplished by the provision of an optical mouse comprising a body defining a case, an optical system for receiving a light beam that was emitted from a light emitter and reflected by a reflection plane to form an image with a lens and converting the formed image into an electrical signal in an image sensor to output the electrical signal, a wheel switch for performing a scroll function by outputting an electric signal caused by rotation of a wheel thereof, and a button unit for outputting an electrical signal as to whether or not respective functional buttons thereof are clicked and based on the number of click operations of the respective functional buttons, wherein: the body has a bottom area sufficient to allow the optical mouse to stand up independently, and also has a pen shape so as to be wrapped around and gripped by the user's thumb and index finger; and the pen shaped body is formed with a protruding portion having an inclined surface suitable to allow the user's middle finger to rest thereon in a state wherein the user's thumb and index finger wrap around and grip the pen shaped body and thus, the middle finger is bent.

Preferably, the bottom area may be in a range of 800 mm² to 2500 mm².

Preferably, an axis of the pen shaped body and a normal line relative to a bottom surface of the pen shaped body may have an angle in a range of 10 degrees to 35 degrees.

Preferably, the optical system may be mounted in the pen shaped body such that the lens thereof is exposed to the outside through a bottom surface of the pen shaped body, and the functional buttons may be mounted at the pen shaped body and the wheel is mounted at the protruding portion, to allow the functional buttons to be clicked and the wheel to be rotated in a state wherein the user's thumb and index finger wrap around and grip the pen shaped body.

Preferably, a cable connecting the optical mouse to a computer may be mounted to the optical mouse through a front surface of a lower portion of the body.

### ADVANTAGEOUS EFFECTS

As stated above, an optical mouse according to the present invention has a pen shape to be gripped by the user's thumb and index finger like a conventional pen mouse, thus causing no stress on the user's wrist in use. Also, the optical mouse of the present invention has a stability and accuracy by virtue of a bottom area thereof sufficient to allow the optical mouse to stand up independently, and can be easily assembled as compared to a conventional pen mouse through the use of a standard optical lens for an optical mouse, resulting in an improved productivity and reduced production costs.

It should be clearly understood that the present invention is not limited to the following description related to an exemplary embodiment of the present invention, and various modifications thereof can be made by those skilled in the art within the scope and spirit of the invention.

### DESCRIPTION OF DRAWINGS

The above and other objects, features and other advantages of the present invention will be more clearly understood from the following detailed description taken in conjunction with the accompanying drawings, in which:

FIGS. 1A and 1B are views illustrating an optical mouse in accordance with an exemplary embodiment of the present invention; and

FIGS. 2 and 3 are views illustrating printed circuit boards used in the optical mouse in accordance with the exemplary embodiment of the present invention.

### BEST MODE

Now, a preferred embodiment of the present invention will be explained in detail with reference to the accompanying drawings.

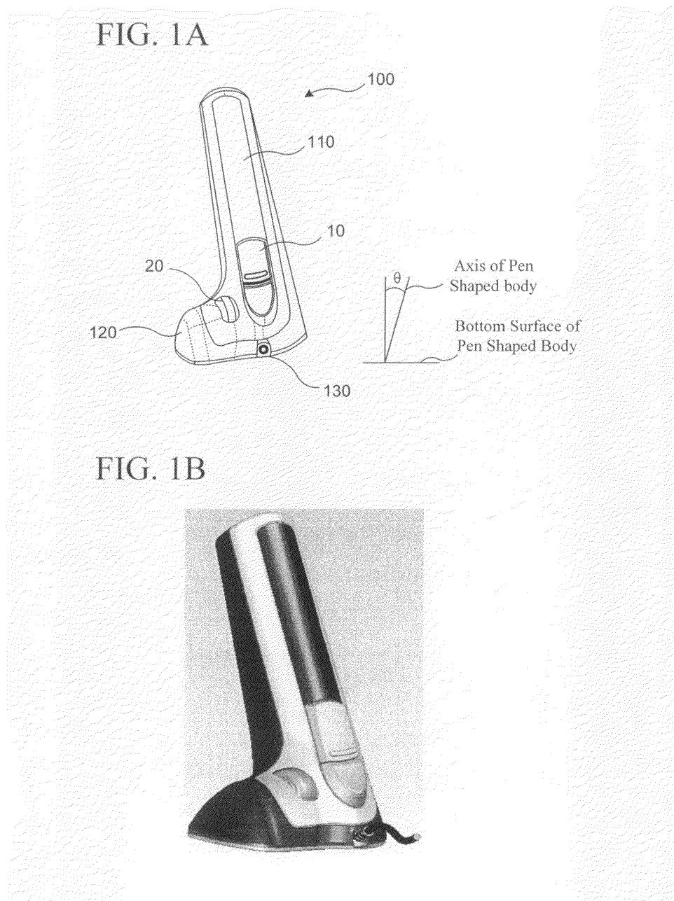

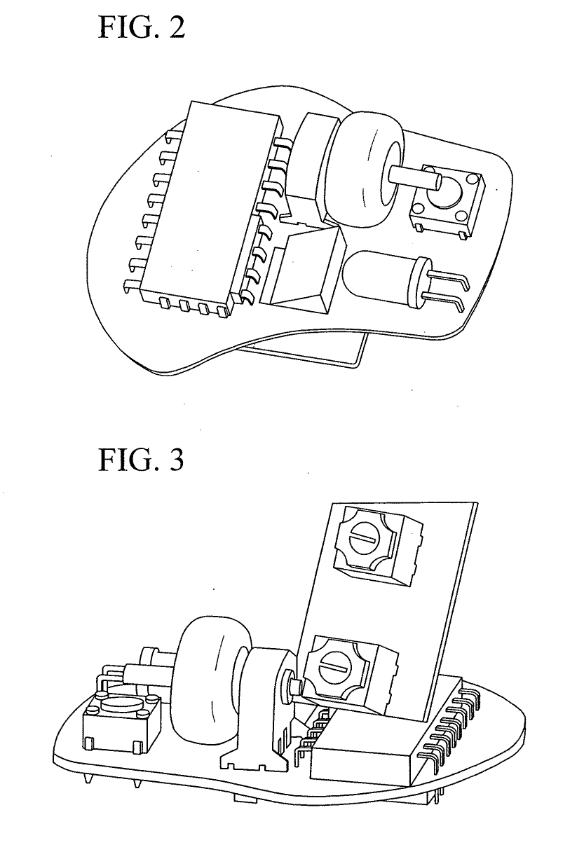

FIGS. 1A and 1B are views illustrating an optical mouse in accordance with an exemplary embodiment of the present invention, and FIGS. 2 and 3 are views illustrating printed circuit boards used in the optical mouse in accordance with the exemplary embodiment of the present invention.

Generally, an optical mouse includes: a body; an optical system; a wheel switch; and a button unit. The present invention is characterized in both the shape of the body of the optical mouse as well as the optimal arrangement of the other constituent elements relative to the body, to overcome drawbacks of a conventional optical desktop mouse and pen mouse. The following description of the optical system, wheel switch and button unit has been made as an example only for a better understanding of the present invention, and the scope of the present invention should not be limited to the following description. Of course, it should be understood that the constituent elements of the optical mouse including the optical system, wheel switch and button unit must be smaller than those of a conventional optical desktop mouse, but be larger than those of a conventional optical pen mouse, and these constituent elements are deformable in shape.

The optical system includes: an LED that serves as a light emitter; a CMOS lens that serves as an image former for receiving a light beam that was emitted from the LED and reflected by a reflection plane, so as to form and output an image; an image sensor for converting the light beam, which was emitted from the CMOS lens and transmitted thereto, into an electrical signal to output the electrical signal; and a microcomputer for analyzing a movement direction of the image formed by the CMOS lens by use of the electrical signal transmitted from the image sensor thereto and transmitting analyzed results to a computer body.

The wheel switch includes: a wheel rotatably coupled to the body of the optical mouse by use of a shaft to partially protrude out of the body through a hole perforated in the body; a rotary encoder for generating a pulse while being rotated together with the wheel; and a printed circuit board for converting the pulse transmitted from the rotary encoder thereto into an electrical signal to output the electrical signal. The wheel switch performs a scroll function by outputting the electrical signal in accordance with rotation of the wheel.

The button unit includes functional buttons that are mounted on a printed circuit board so as to be clicked by the user's finger, and is adapted to output an electrical signal from the printed circuit board as to whether or not each of the buttons is clicked and based on the number of click operations of each button. For example, if the user's finger is moved forward and rearward in a state wherein a left one of the buttons is clicked, an electrical signal that commands designation of a scrolled region is outputted from the printed circuit board. Also, if a right one of the buttons is clicked, an electrical signal that commands display of a pop-up menu window is outputted from the printed circuit board.

Referring to FIG. 1, the optical mouse according to the present invention, which is designated as reference numeral 100, includes a body 110, which has a pen shape to be gripped by the user's thumb and index finger and is provided with a bottom surface suitable to allow the optical mouse to stand up independently. The body having the above described configuration has the effect of providing the optical mouse with a stability in use like a desktop mouse, and causing no stress on the user's wrist like a pen mouse. In the present invention, it is allowable that a bottom area of the optical mouse is smaller than that of a desktop mouse, but larger than that of a pen mouse, preferably, the bottom area is in a range of 800 to 2500 mm² for the sake of the convenient use of the optical mouse. Also, to optimize the grip comfort of the optical mouse to the maximum extent, the pen shaped body of the optical mouse is configured such that an axis of the pen shaped body and a normal line relative to the bottom surface of the pen shaped body have an angle θ in a range of 10 to 35 degrees. The pen shaped body 110 is formed with a protruding portion 120 having an inclined surface suitable to allow the user's middle finger to rest thereon in a state wherein the thumb and index finger wrap around and grip the pen shaped body and thus, the middle finger is bent. With this configuration, accordingly, the optical mouse of the present invention has no risk of causing stress on the user's wrist in use, and can achieve a stability in use because it has a bottom area sufficient to allow the optical mouse to stand up independently. Also, the optical mouse of the present invention can be easily assembled as compared to a conventional pen mouse, resulting in an improved productivity.

Hereinafter, the arrangement of the optical system, wheel switch and button unit with respect to the body of the optical mouse 100 according to the present invention as stated above will be explained as an example.

The optical system is mounted in the pen shaped body such that the lens thereof (not shown) is exposed to the outside through the bottom surface of the pen shaped body 110. The pen shaped body 110 is also mounted with functional buttons 10 of the button unit at appropriately selected positions and a wheel 20 of the wheel switch at a position of the protruding portion 120, to allow each functional button 10 to be clicked or the wheel 20 to be rotated by the user's index finger in a state wherein the user's thumb and index finger wrap around and grip the pen shaped body 110. In the installation of the optical system, button unit and wheel switch, the embodiment of the present invention describes that, for the sake of maximizing the utility of space, the optical system and wheel switch are arranged on a single printed circuit board as shown in FIG. 2, and the button unit is arranged on another printed circuit board as shown in FIG. 3. In this case, since the axis of the pen shaped body and the normal line relative to the bottom surface of the pen shaped body have an angle of 10 to 35 degrees as stated above, it can be understood that the printed circuit board provided with the button unit is obliquely installed relative to the printed circuit board provided with the wheel switch.

As known, a conventional pen mouse has a structural limit in that a cable connecting the mouse to a computer should be coupled to the mouse through an upper portion of the mouse, and therefore, is inconvenient in use because the cable may be wound on the user's wrist. However, when using the body according to the present invention, the cable may be mounted to the optical mouse through a front surface 130 of a lower portion of the body. Meanwhile, it can be understood that the optical mouse according to the present invention may take the form of a wireless optical mouse.

1. An optical mouse comprising a body defining a case, an optical system for receiving a light beam that was emitted from a light emitter and reflected by a reflection plane to form an image with a lens and converting the formed image into an electrical signal in an image sensor to output the electrical signal, a wheel switch for performing a scroll function by outputting an electric signal caused by rotation of a wheel thereof, and a button unit for outputting an electrical signal as to whether or not respective functional buttons thereof are clicked and based on the number of click operations of the respective functional buttons, wherein:
the body has a bottom area sufficient to allow the optical mouse to stand up independently, and also has a pen shape so as to be wrapped around and gripped by the user's thumb and index finger; and
the pen shaped body is formed with a protruding portion having an inclined surface suitable to allow the user's middle finger to rest thereon in a state wherein the user's thumb and index finger wrap around and grip the pen shaped body and thus, the middle finger is bent.

2. The optical mouse according to claim 1, wherein the bottom area is in a range of 800 mm² to 2500 mm².

3. The optical mouse according to claim 1, wherein an axis of the pen shaped body and a normal line relative to a bottom surface of the pen shaped body have an angle in a range of 10 degrees to 35 degrees.

4. The optical mouse according to claim 1, wherein:
the optical system is mounted in the pen shaped body such that the lens thereof is exposed to the outside through a bottom surface of the pen shaped body; and
the functional buttons are mounted at the pen shaped body and the wheel is mounted at the protruding portion, to allow the functional buttons to be clicked and the wheel to be rotated in a state wherein the user's thumb and index finger wrap around and grip the pen shaped body.

5. The optical mouse according to claim 1, wherein a cable connecting the optical mouse to a computer is mounted to the optical mouse through a front surface of a lower portion of the body.

6. The optical mouse according to claim 1, wherein the optical mouse has a wireless form.
